(19) United States
(12) Patent Application Publication
(10) Pub. No.: US 2021/0238868 A1
(43) Pub. Date: Aug. 5, 2021

(54) CORNER BEAD SQUARE AND SPACKLE APPLICATOR

(71) Applicant: Shark Toolers, a dba of Stathis & Liebesfeld, LLC, Morris Plains, NJ (US)

(72) Inventor: James Stathis, Morris Plains, NJ (US)

(21) Appl. No.: 16/778,219

(22) Filed: Jan. 31, 2020

(51) Int. Cl. E04F 21/165; B25G 1/10

(52) U.S. Cl. CPC E04F 21/1655; B25G 1/102

(57) ABSTRACT

A simple, hand-held tool for installing dry wall corner bead to obtain a consistent, square, smooth surface and enabling an installer to apply spackle evenly through the entire length and height of the corner without any bumps or protrusions. With an optional angle adjuster, corners of other than ninety degrees can be similarly installed.

### FIELD OF THE INVENTION

A simple, hand-held tool for installing dry wall corner bead to obtain a consistent, square, smooth surface and enabling an installer to apply spackle evenly through the entire length and height of the corner without any bumps or protrusions. With an optional angle adjuster, corners of other than ninety degrees can be similarly installed.

### BACKGROUND

Constructing walls from drywall involves many corners. Corner bead is a pre-fabricated corner edging that is applied to both sides of a corner to stabilize and strengthen the outside corner edges of drywall. The drywall corner bead generally has holes on either side through which it can be attached via screws or drywall nails. There also exist clinch-on tools that crimp portions of metal corner bead into the drywall, essentially forming its own nail. The crimping procedure is not meant to permanently attach the corner bead, only to secure it temporarily, straight, until it is permanently attached with nails.

However, the crimp tools can leave little bits of crimped metal protruding and can be difficult to use and thus, it is complex and difficult to keep corner bead straight and secure and leave a desirable surface for applying drywall compound, which is applied over the corner bead to make the complete outside surface of the drywall—flat sections and corners—uniformly smooth and consistent, and square and true.

Thus, there are two components to drywall corners. First, and after the main pieces of drywall are secured in place, is to install drywall corner bead; and second, is to then apply drywall compound over the corner bead. Of course, there is then sanding and painting, but for purposes here, we are only concerned with getting from the point where the main drywall has been put up, to getting to a secure, stable, straight, corner edge ready for finishing. The difficulties lie in attaching the corner bead in the first instance so that it is straight and true and firmly secure, and then in the second instance, having a surface that is easy to apply drywall compound without interfering metal protrusions and actually applying the compound in a uniform manner.

There have been attempts to solve the difficulties noted. For example, in U.S. Pat. No. 2,468,167 titled SETTING GAUGE FOR CORNER BEADS, disclosed is, “a setting gauge for corner beads and is designed to assist a plasterer in making window recesses which are perfectly square and plumb . . . comprising two arms having edges defining a right angle, a gauge member having an edge slidable on one of said arms, and means mounted on said gauge member for gripping of a corner bead.”

In another example, U.S. Pat. No. 8,151,405 B2 titled DRYWALL TROWEL, discloses, “a tool for spreading viscous material comprising a sheet of resilient material having an inner face and an outer face, a handle attachment edge and a forward edge. The sheet being bent from the outer face toward the inner face along a bend line to form a V-shaped point to shape an offset corner blade and at least one substantially flat surface blade from the forward edge, and a handle for gripping the tool attached to the handle attachment edge of the sheet distal distally from the end line.”

In another example, U.S. Pat. No. 9,051,744 titled HAND HELD BUILDING TOOLS, discloses “various tools such as trowels, knives, and scrapers may be made having at least a portion of their blades heat treated to make at least their working edges more durable and extend their useful lives.”

In another example, U.S. Pat. No. 5,613,335 titled PAPERBEAD FOR PROTECTING DRYWALL CORNERS, discloses, an “approved corner bead for drywall construction having a paper layer bonded to an exterior surface of a formed metal or plastic core. The paper is impregnated with a latex prior to affixing it to the core. The uniformly impregnated paper provides improved protection against adverse abrasion at all levels of thickness of the paper.”

In another example, U.S. Pat. No. 4,977,718 titled BENT POSITION RETENTION FLEXIBLE CORNER BEAD STRIP discloses, “an improved flexible corner bead strip usable for reinforcing a drywall corner. The corner bead strip comprises first and second plastic strips each of which has a substantial longitudinal dimension and corresponding with the length of the drywall corner to be reinforced. Each of the first and second plastic strips also has a transverse dimension which defines a corner line formed from the respective central and abutting edges thereof. A flexible V-shaped hinge is disposed at the respective central and abutting edges of the first and second plastic strips forming a corner line to enhance retention of the first and second plastic strips in the bent position. A drywall compound adhering surface is formed and bounded by the exterior surface of the wings of the V-shaped hinge and the attached plastic strip surface which accommodating extends laterally thereacross for containing dry wall compound therewithin.”

Finally, in another example, U.S. Pat. No. 6,282,937 titled, CORNER BEAD RESHAPING TOOL, discloses, “a tool for reshaping corner bead, which is perforated right angle metal strip used in fabrication of corners in drywall building construction, spreads the legs of 90 degree angle corner bead outwardly to increase the included angle thereof. The bead is rolled between a pressure roller and a multiplicity of idler rollers. The apex of the bead runs in a circumferential groove of the vertically adjustable pressure roller which presses downwardly as the legs ride upon idler rollers which resist the downward force while allowing sideward motion of the legs. Preferably, the rollers are comprised of mated pairs of hemispheres and the bead is made to pass through the tool by driving the pressure roller with a screw gun. The frame of the tool has a detachable tang which enables the tool to be mounted from the side wall pocket of a common pickup truck box.

None of the foregoing references, alone or in combination, teach the salient and proprietary features or construction of the present disclosure, and as such, fail to be useful as a simple tool for insuring that drywall corner bead is applied uniform, square, true and easily, and without leaving behind any fragmentation or deformation to make spreading drywall compound over the corner bead difficult, and, finally assist with uniformly spreading the drywall compound. In some embodiments, the device disclosed can be adjusted for other than ninety degree corners.

The present disclosure teaches several embodiments that provide a proprietary handle, easy to hold, even if hands are sticky or wet, that holds a square for uniformly pressing drywall corner bead at exactly the right position over an outside corner edge of installed drywall sheets, accounting for the thickness of the corner bead, the depth or width on both edges of the corner bead and corner bead itself. This allows an installer to hold the corner bead in place, knowing it is exactly in the right place, using a nail gun or staple gun to secure the corner bead in place, and move on to the next length, confident that the corner bead will be uniform and truly square. Finally, in one embodiment, it can also serve as a drywall applicator knife.

### SUMMARY

The present disclosure teaches embodiments of a device that comprise: (a) a proprietary handle, further comprising, a bulbous shape to fit securely in the palm of one hand with room for fingers to wrap around, and a center indentation where a thumb can rest for easy maneuverability; (b) a first side of a square comprising one end attached to the handle, an opposite end, an inside edge extending from slightly past the first end to the opposite end wherein at the opposite end, there is a slight protrusion; and (c) a second side of a square comprising one end attached to the handle, an opposite end, an inside edge extending from slightly past the first end to the opposite end wherein at the opposite end, there is a slight protrusion; wherein said first side of a square and said second side of a square form a joint having an angle at both first one ends and further where the angled joint is formed, there is a slight bead formed.

In one embodiment, the angled joint formed is ninety degrees.

In other embodiments, the angled joint can be any number of degrees from one to one hundred seventy-nine to match the outside corner angle of any drywall installation.

In one embodiment, the angled joint can be changed by the user via a means to open and close the angled square around a joint pivot.

In one embodiment, the first and second sides of a square can be formed from a material chosen from any known material that is sturdy, lightweight, easy to manufacture, and durable, such as metal, plastic, plexiglass, or any other such substance. In a preferred embodiment, the material is aluminum.

In one embodiment, the handle can be formed from a material chosen from any known material that is sturdy, durable, lightweight, comfortable in the hand, and easy to manufacture. In one embodiment, the material can be the same as the material chosen for the square sides. In one embodiment, the material can different from the material chosen for the square sides. In a preferred embodiment, the material for the handle is plastic.

In one embodiment, the handle can separate when desired, in order for the square to be replaceable if it should become damaged or dirty. In one embodiment, the replaceability of the squares could also allow interchangeability of the angles, so that other than ninety-degree corners could be easily accommodated. In one embodiment, the separability could be enabled through a screw fastener, or a snap together fastener, or any known fastening mechanism for two sides of a handle/bracket.

### BRIEF DESCRIPTION OF THE DRAWINGS

FIG. 1 depicts one embodiment of a handheld corner bead square comprising a handle (1) having a center indentation (2), a first side of a square (3), a second side of a square (4), a protrusion on the inside edge of the first side of the square at its opposite end (5), a protrusion on the inside edge of the second side of the square at its opposite end (6) and a bead cutout at the joining edges forming an angle of the inside edges of both sides of the square (7).

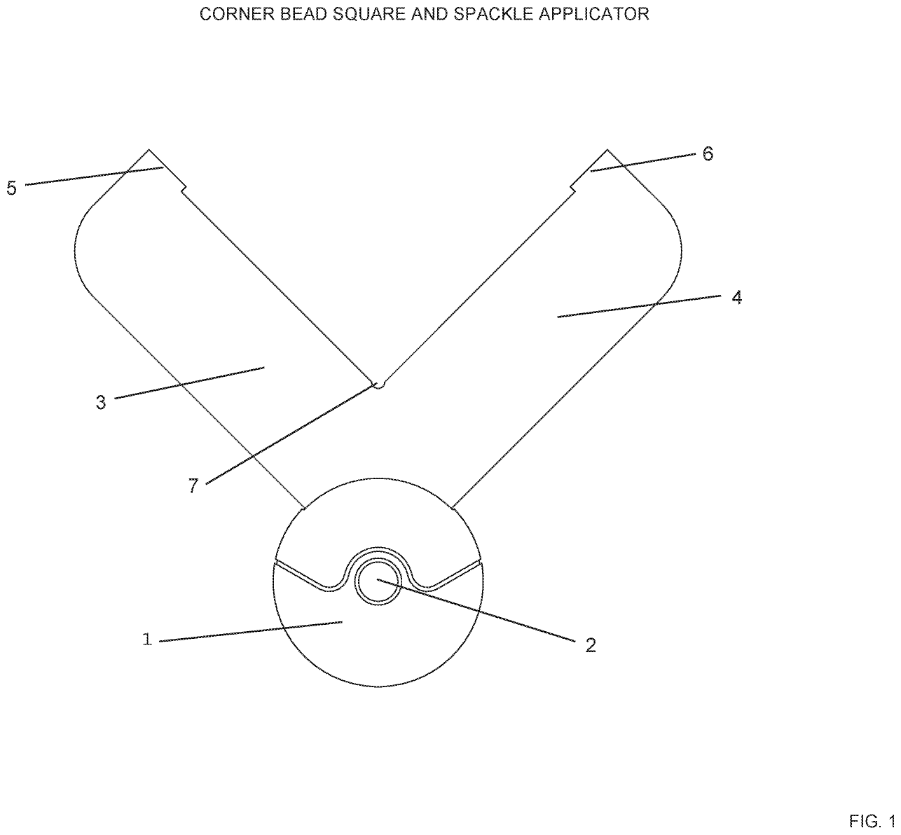

FIG. 2 depicts one embodiment of a handheld corner bead square comprising a handle (1) having a contoured width (8).

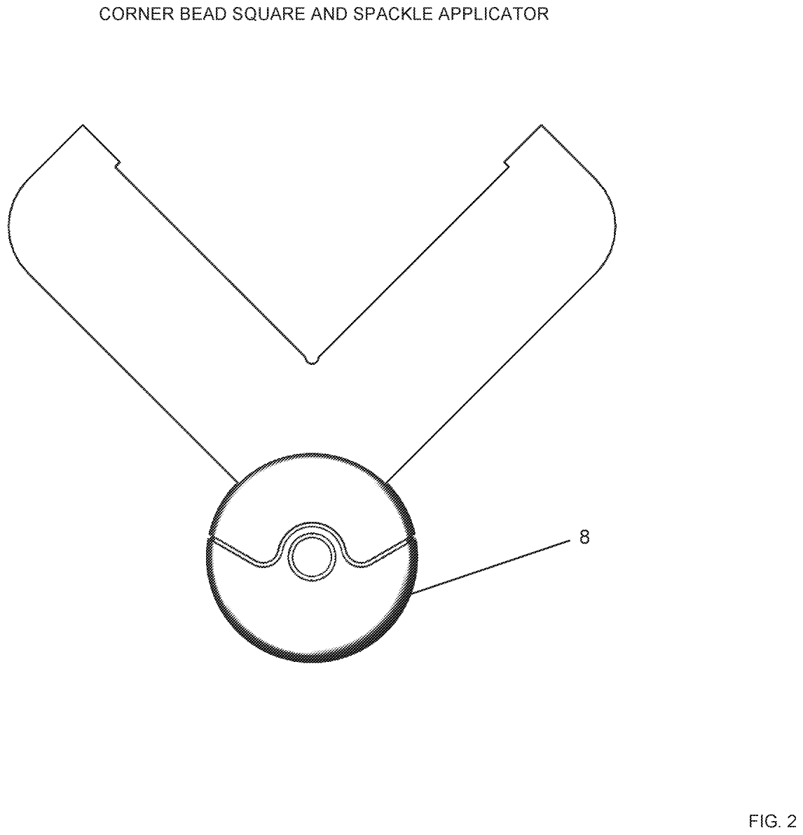

FIG. 3 depicts one embodiment of a handheld corner bead square, in an aspect view to show the relative widths of the various components, comprising a handle (1) having a center indentation (2), a first side of a square (3), a second side of a square (4), a protrusion on the inside edge of the first side of the square at its opposite end (5), a protrusion on the inside edge of the second side of the square at its opposite end (6) and a bead cutout at the joining edges forming an angle of the inside edges of both sides of the square (7).

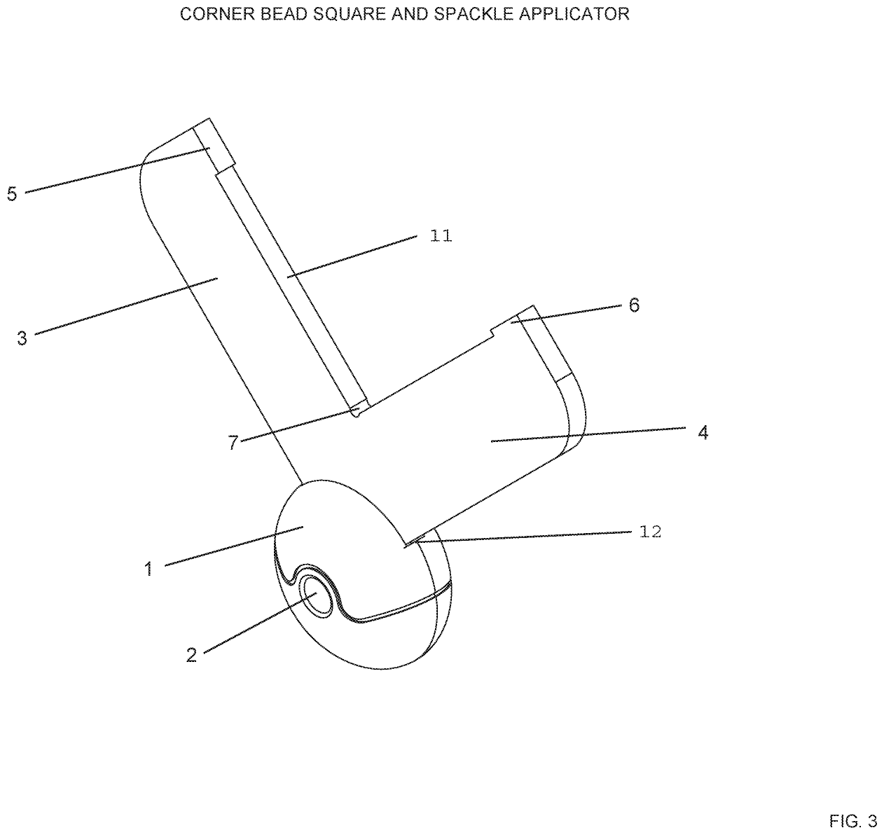

FIG. 4 depicts one embodiment of a handheld corner bead square, in a side view.

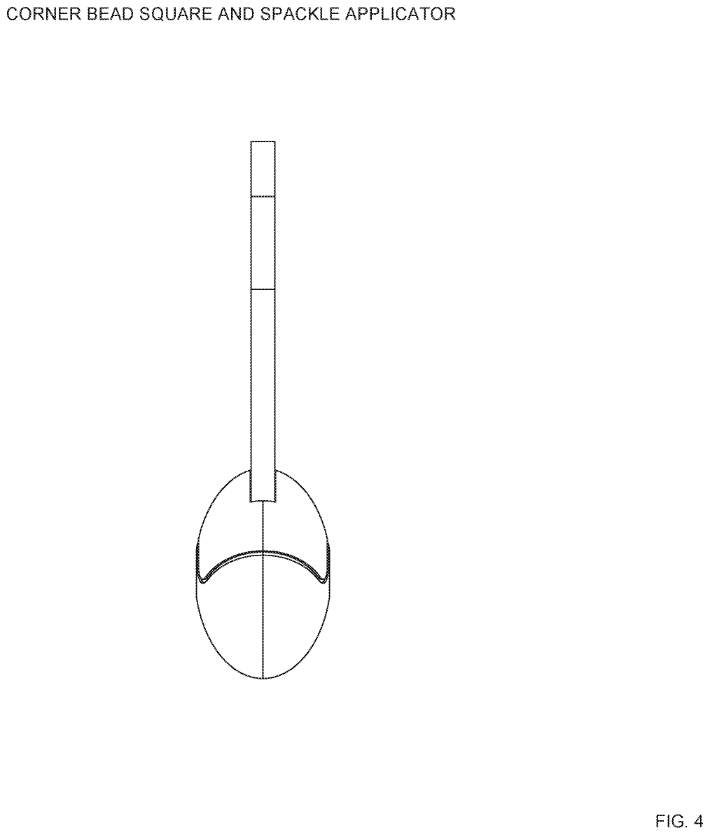

FIG. 5 depicts one embodiment of a handheld corner bead square, in a top view.

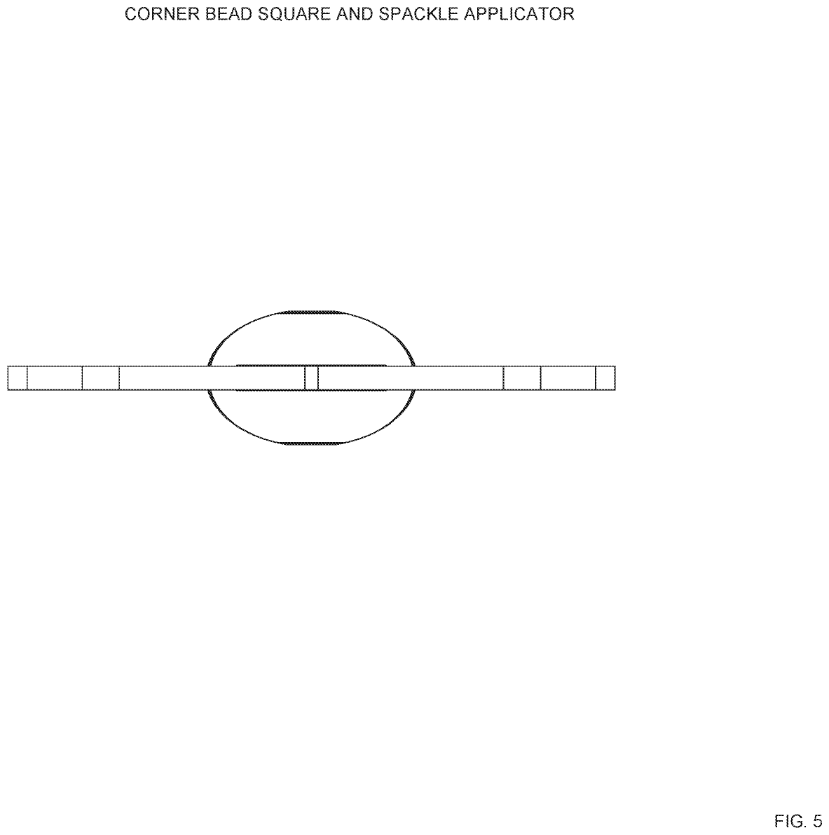

FIG. 6 depicts one embodiment of a handheld corner bead square, comprising a handle having a center indentation, a first side of a square (3), a second side of a square (4), a protrusion on the inside edge of the first side of the square at its opposite end, a protrusion on the inside edge of the second side of the square at its opposite end and a bead cutout at the joining edges forming an adjustable angle of the inside edges of both sides of the square wherein the bottom portion of the first end of the first side of the square (8) is hollow and attached at a pivot point (10) and the bottom portion of the first end of the second side of the square (9) is thin enough to fit inside the hollow of the first side and also attached at the pivot point (10) such that the pivot forms a rotatable junction.

### DETAILED DESCRIPTION

For clarity of disclosure, and not by way of limitation, the detailed description of the invention is divided into the following subsections that describe or illustrate certain features, embodiments or applications of the present invention.

### Definitions

“square” as used herein means a device consisting of two straight edges set at a particular angle to each other, usually ninety-degrees, often used by carpenters and machinists for checking the correctness of angles of construction. While ‘square’ implies a right angle, for purposes here, square implies the tool, not necessarily the shape, and can be any angle.

“side of a square” as used herein means one leg or one of the two straight edges of a square having a thickness, a width, and a particular angle as set in relation to the other side of a square, as in a first and second side of a square.

“proprietary handle” as used herein means a substantially circular, bulbous device, approximately the size to comfortably fit in an average hand, but could be custom sized to fit any hand, comprising a substantially smooth outer surface with an indentation in the center of either or both sides to rest a thumb, and comprising an inner area configured to attach a square.

### The System and Method of the Present Invention

A typical device as described herein comprises a proprietary handle (1) with an indentation (2), approximately the size of a large yo-yo, having one-quarter of its circumferential edge (12) hollowed and configured to accept a square, the square having a first side (3) and a second side (4) configured to form a right angle, and wherein both sides have a length configured to extend just beyond the length of traditional corner-bead, and the open ends of both sides having a notch (5, and 6) that are configured to rest against the surface of drywall where corner-bead is being installed and allowing for just the thickness of traditional corner-bead, and further comprising a small bead notch at the right angle formed (7), again to just allow for the shape of traditional corner-bead, such that when pressed up against corner-bead in place over a corner edge of newly constructed drywall, the device as described holds the corner-bead firmly in place allowing a user to then permanently secure in place with a nail gun, stable gun or other fastener.

In one embodiment, the width (11) of the first and second sides of the square (3, and 4) as described herein are approximately ¼″, just thick enough to securely hold corner-bead in place firmly and uniformly against drywall.

In one embodiment, the protruding notches (5, and 6) of the first and second sides of a square (3, and 4) are approximately ½″ long, extending past the inner edge of the sides of the square.

In one embodiment, the proprietary handle can separate into two halves, and reattach via a screw, or snaps, or other known fastening/joining mechanism. In this embodiment, the purpose could be to replace the square should the square become damaged, bent, or dirty. Another reason to replace the square would be if it were desirable to have a different than ninety-degree angle. In one embodiment, there could be a set of squares wherein there could be a forty-five degree angle, a seventy-five degree angle, or any desired degree angle in addition to the ninety-degree angle. Then, when other than ninety-degree angle corner-bead is being installed, it would be a simple switch out of the angled square and the same benefits would attach.

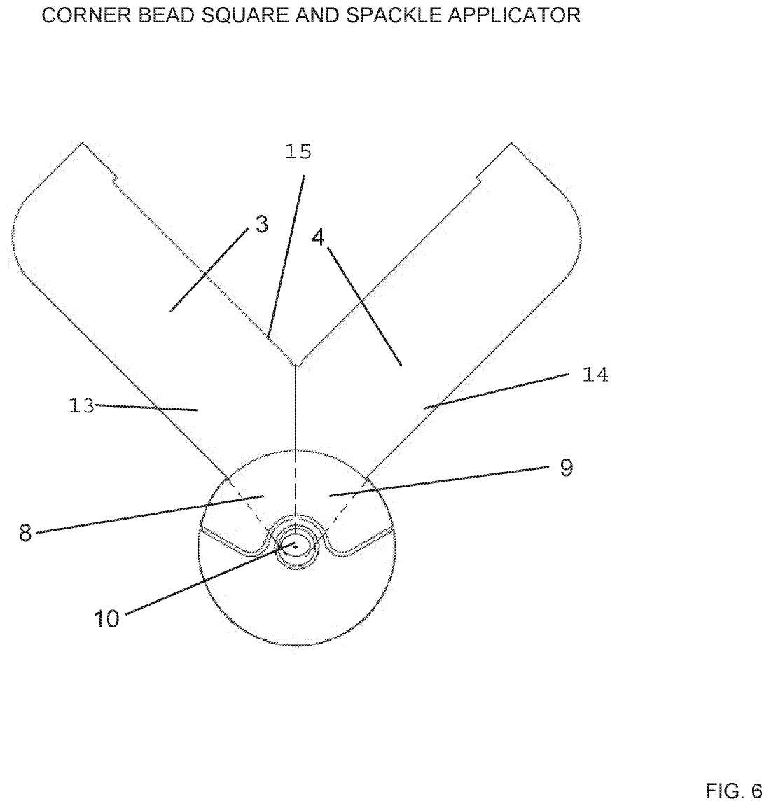

In one embodiment, the square could be pivotable to change angles without removing from the proprietary handle. As shown in FIG. 6, there could be a first side of a square (13) that has a hollow interior (15) and the second side of a square (14) would be configured to be thinner than the width of the hollow first side such that it would fit partially inside. The two sides would be joined at a pivot point (10) making the two sides rotatable around the pivot point and the angle could then be adjustable. There could be snap notches on the surface of the sides so that the two sides could snap into place at various common desired angles. In an alternative embodiment, the two sides could adjust around a pivot with the use of a screw adjustment making the angle secure at any given angle desired.

### Examples

The present invention is further illustrated, but not limited by, the following examples.

A typical use of the device as described herein is to assist an installer to affix corner-bead to the outside corner edge of drywall. After installing drywall, where edges meet to form a corner, corner-bead is positioned over the exposed edges to provide stability and uniformity. However, it must be installed true and square in order to be effective. Moreover, some installation methods, such as with crimping tools, leave shards of metal exposed that will make spackling over the corner bead difficult. Here, the installer simply places the device over the corner-bead in place and press firmly against the outside corner automatically positioning the corner-bead in the correct placement. This can be accomplished with only one hand leaving the other hand free to then staple gun or nail gun the corner bead firmly into place at just the right position. The device is then moved up or downward along the length of the corner bead securing the next portion of corner-bead into position, again only requiring one hand to hold the tool, the other hand free to use a nail gun or staple gun to secure that next portion of corner-bead into position. The corner-bead installed in this fashion will be secure, uniformly positioned straight and true, and be ready to accept an outer coating of spackle without and metal scrapings or shards from a crimping tool.

In installations where other than a ninety-degree angle is desired, the device as described herein in various embodiments, can accommodate other than ninety-degree angles.

Additionally, when it comes time to spread and apply the spackle over the attached corner-bead, the device can also act as a spackle knife, uniformly applying spackle compound or mud over the outside edge of the corner bead. The device as described in some embodiments having a solid construction is easily cleaned.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

Each and every feature described herein, and each and every combination of two or more of such features, is included within the scope of the present invention provided that the features included in such a combination are not mutually exclusive.

What is claimed is:

1. A device comprising:
a proprietary handle, further comprising, a bulbous shape configured to fit securely in the palm of one average human hand with room for fingers to wrap around, and a center indentation where a thumb can rest for easy maneuverability, and a hollow portion configured to allow the insertion and securement of a square;
a first side of a square further comprising a first end attached to the hollow of the proprietary handle, a second opposite end, an inside edge extending from slightly past the first end to the opposite end wherein at the opposite end, there is a slight protrusion; and
a second side of a square further comprising a first end attached to the hollow of the proprietary handle, a second opposite end, an inside edge extending from slightly past the first end to the opposite end wherein at the opposite end, there is a slight protrusion;
wherein said first side of a square and said second side of a square form a joint having an angle formed at the joint of both inside edges and further where the angled joint is formed, there is a slight bead notch.

2. The apparatus of claim 1, wherein said angle formed at the joint of both inside edges is ninety-degrees.

3. The apparatus of claim 1, wherein said proprietary handle is separable and re-attachable.

4. The apparatus of claim 1 wherein said first side of a square and said second side of a square are rotatable around a pivot point.

5. The apparatus of claim 1 wherein the proprietary handle is plastic and the first and second sides of the square are aluminum.
